(19) United States
(12) Patent Application Publication
(10) Pub. No.: US 2020/0372114 A1
(43) Pub. Date: Nov. 26, 2020

(54) AUTOMATIC TRANSLATING AND SYNCHRONIZATION OF AUDIO DATA

(71) Applicant: INTERNATIONAL BUSINESS MACHINES CORPORATION, ARMONK, NY (US)

(72) Inventors: John J. Auvenshine, Tucson, AZ (US); Anthony Ciaravella, Tucson, AZ (US); John T. Olson, Tucson, AZ (US); Richard A. Welp, Manchester (GB)

(21) Appl. No.: 16/417,767

(22) Filed: May 21, 2019

(51) Int. Cl. G06F 17/28; G10L 15/22; G10L 15/26; G10L 15/04; G10L 13/04

(52) U.S. Cl. CPC G06F 17/289; G10L 15/22; G10L 13/043; G10L 15/04; G10L 15/265

(57) ABSTRACT

Methods, systems, and computer program products for media language translation and synchronization are provided. Aspects include receiving, by a processor, audio data associated with a speaker, wherein the audio data is in a first language, determining speaker characteristics associated with the speaker from the audio data, converting the audio data to a source text in the first language, converting the source text to a target text, wherein the target text is in a second language, and generating an output audio in the second language for the target text based on the speaker characteristics.

### BACKGROUND

The present invention generally relates to media language translations, and more specifically, to a system to automatically translate and synchronize audio data.

Most media content involves spoken words including radio content, television content, speeches, movies, news content, and educational programming. The media content usually includes speaker audio only, speaker audio with sound effects, speaker audio with video, or any combination of each. Due to the proliferation of media over the internet, there are media consumers that may not understand the original language for media content and would require either subtitles or some sort of audio translation.

### SUMMARY

Embodiments of the present invention are directed to a computer-implemented method for media language translation and synchronization. A non-limiting example of the computer-implemented method includes receiving, by a processor, audio data associated with a speaker, wherein the audio data is in a first language, determining speaker characteristics associated with the speaker from the audio data, converting the audio data to a source text in the first language, converting the source text to a target text, wherein the target text is in a second language, and generating an output audio in the second language for the target text based on the speaker characteristics.

Embodiments of the present invention are directed to a system for media language translation and synchronization. A non-limiting example of the system includes a processor configured to perform receiving, by a processor, audio data associated with a speaker, wherein the audio data is in a first language, determining speaker characteristics associated with the speaker from the audio data, converting the audio data to a source text in the first language, converting the source text to a target text, wherein the target text is in a second language, and generating an output audio in the second language for the target text based on the speaker characteristics.

Embodiments of the invention are directed to a computer program product for media language translation and synchronization, the computer program product comprising a computer readable storage medium having program instructions embodied therewith. The program instructions are executable by a processor to cause the processor to perform a method. A non-limiting example of the method includes receiving, by a processor, audio data associated with a speaker, wherein the audio data is in a first language, determining speaker characteristics associated with the speaker from the audio data, converting the audio data to a source text in the first language, converting the source text to a target text, wherein the target text is in a second language, and generating an output audio in the second language for the target text based on the speaker characteristics.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 depicts a block diagram of a computer system for use in implementing one or more embodiments of the present invention;

FIG. 4 depicts a block diagram of a system for media language translation and synchronization according to one or more embodiments of the invention; and

FIG. 5 depicts a flow diagram of a method for media language translation and synchronization according to one or more embodiments of the invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

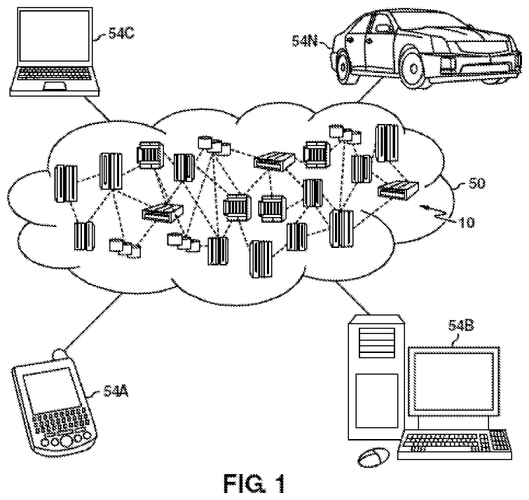

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

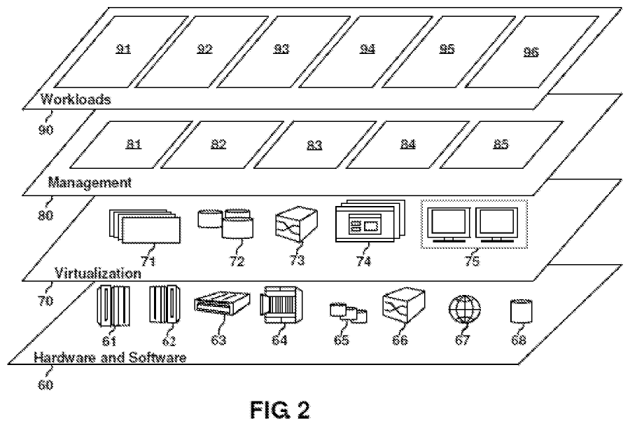

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and audio data translation and synchronization 96.

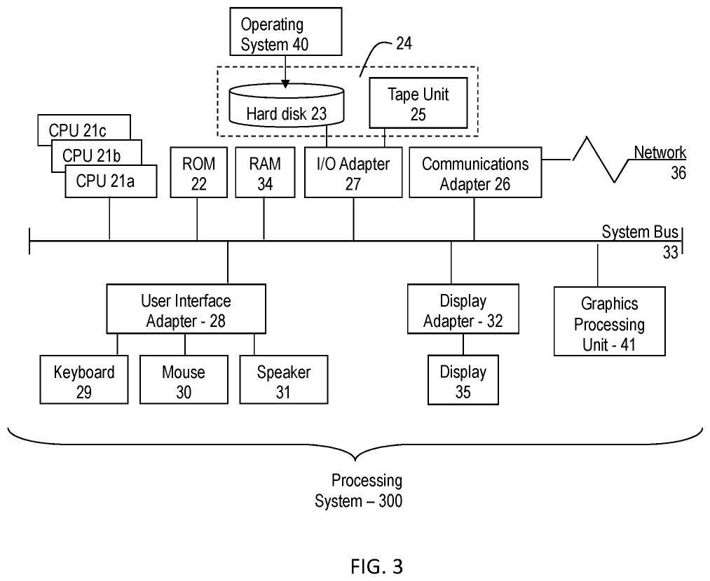

Referring to FIG. 3, there is shown an embodiment of a processing system 300 for implementing the teachings herein. In this embodiment, the system 300 has one or more central processing units (processors) 21a, 21b, 21c, etc. (collectively or generically referred to as processor(s) 21). In one or more embodiments, each processor 21 may include a reduced instruction set computer (RISC) microprocessor. Processors 21 are coupled to system memory 34 and various other components via a system bus 33. Read only memory (ROM) 22 is coupled to the system bus 33 and may include a basic input/output system (BIOS), which controls certain basic functions of system 300.

FIG. 3 further depicts an input/output (I/O) adapter 27 and a network adapter 26 coupled to the system bus 33. I/O adapter 27 may be a small computer system interface (SCSI) adapter that communicates with a hard disk 23 and/or tape storage drive 25 or any other similar component. I/O adapter 27, hard disk 23, and tape storage device 25 are collectively referred to herein as mass storage 24. Operating system 40 for execution on the processing system 300 may be stored in mass storage 24. A network adapter 26 interconnects bus 33 with an outside network 36 enabling data processing system 300 to communicate with other such systems. A screen (e.g., a display monitor) 35 is connected to system bus 33 by display adaptor 32, which may include a graphics adapter to improve the performance of graphics intensive applications and a video controller. In one embodiment, adapters 27, 26, and 32 may be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 all interconnected to bus 33 via user interface adapter 28, which may include, for example, a Super I/O chip integrating multiple device adapters into a single integrated circuit.

In exemplary embodiments, the processing system 300 includes a graphics processing unit 41. Graphics processing unit 41 is a specialized electronic circuit designed to manipulate and alter memory to accelerate the creation of images in a frame buffer intended for output to a display. In general, graphics processing unit 41 is very efficient at manipulating computer graphics and image processing and has a highly parallel structure that makes it more effective than general-purpose CPUs for algorithms where processing of large blocks of data is done in parallel.

Thus, as configured in FIG. 3, the system 300 includes processing capability in the form of processors 21, storage capability including system memory 34 and mass storage 24, input means such as keyboard 29 and mouse 30, and output capability including speaker 31 and display 35. In one embodiment, a portion of system memory 34 and mass storage 24 collectively store an operating system coordinate the functions of the various components shown in FIG. 3.

Turning now to an overview of technologies that are more specifically relevant to aspects of the invention, for media translations into different languages from the original language of the media content, the media content is manually translated into the text of the different languages and then displayed as text over a video screen (i.e., “subtitles”). These subtitles are typically created manually by people who speak both the source language and the target (translation) language. Some subtitles can be created with speech recognition and automated translations as well. Subtitles have certain drawbacks in terms of presentation to an individual attempting to view the media content. For example, a viewer is forced to read the subtitles on a screen instead of hearing the subtitles in their language. For viewers who are unable to read or unable to keep up with the subtitles, these viewers would miss the visual components of the media content. In addition, some visual components might be obscured by the subtitles on the screen. Other approaches to translations include manually translating the original language and then utilizes individuals to recite the target language over the voices of the original speakers as a substitute. This practice is known as a dub or dubbing. However, dubbing is typically not done in the original speaker's voice unless the speaker is able to speak in the target language. Also, with multiple target languages, it is difficult to find a speaker that can communicate in more than a couple of languages. And with dubbing utilizing additional voice actors for different languages, it can be expensive and time-consuming.

Turning now to an overview of the aspects of the invention, one or more embodiments of the invention address the above-described shortcomings of the prior art by providing systems and methods for automatically translating and time synchronizing audio data for media content. Aspects include sampling a speaker's voice in a source language including collecting sound samples of phonemes in the speaker's voice. Phonemes refer to one of the units of sound that distinguish one word from another in a particular language. A voice recognition engine is utilized for audio data in the source language of the speaker to translate into textual data in the source language. The textual data in the source language is translated into textual data for a target source language. This translated textual data is utilized with sampled phoneme data for the original speaker to obtain audio data of the original speaker in the target language. Embodiments of the invention utilize audio compression and audio expansion to make the audio in the target language take up a same amount of time, inflection, etc. as used by the original speaker in the source language.

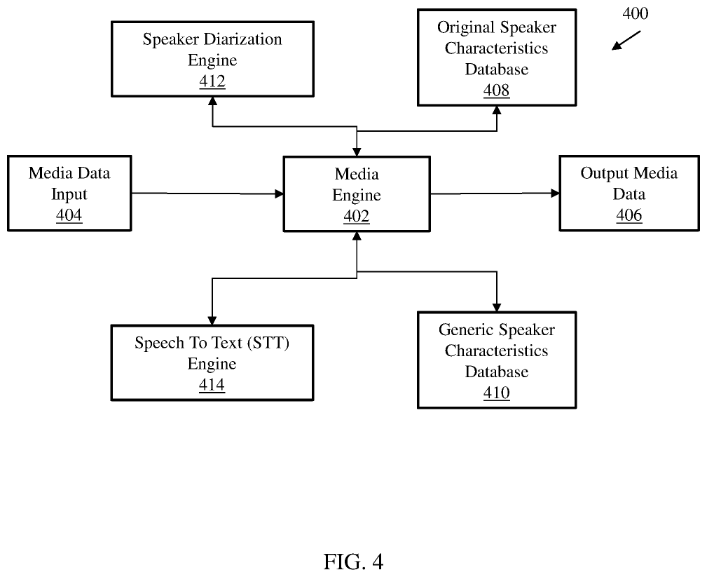

Turning now to a more detailed description of aspects of the present invention, FIG. 4 depicts a block diagram of a system for media language translation and synchronization according to one or more embodiments of the invention. The system 400 includes a media engine 402 that is configured to receive a media data input 404 that has audio data in a first language and translate the audio data into an output media data 406 in a second (target) language. The media engine 402 receives the media data input 404. The media data input 404 can include audio data only or a combination of audio and video data with one or more speakers. The audio from the media data input 404 can be analyzed by the media engine 402 to extract speaker characteristics for each speaker in the audio and store this in an original speaker characteristics database 408. In embodiments of the invention, the speaker characteristics can include tone, vocal range, accents, cadence, and any other characteristics associated with how a speaker communicates vocally. In addition, phonemes that include sound samples of a speaker's voice are extracted and stored in the original speaker characteristics database 408. Also, a generic speaker characteristics database 410 can be accessed by the media engine 402. The generic speaker characteristics database 410 include characteristics and phonemes of various speakers other than the original speakers in the audio data. The various speakers can cover a range of speaking characteristics to be later used to fill in any missing phonemes that are not available in the original speaker's voice.

In one or more embodiments of the invention, the media engine 402 can utilize a speaker diarization engine 412 and a speech to text (STT) engine 414 to translate, transcribe, and partition the audio data. The speaker diarization engine 412 can be utilized for speech recognition and to identify speakers in audio data. Speaker diarization is the process of partitioning an input audio stream into homogeneous segments according to the speaker identity. It can enhance the readability of an automatic speech transcription by structuring the audio stream into speaker turns and providing the speaker's true identity. It is used to answer the question “who spoke when?” Speaker diarization is a combination of speaker segmentation and speaker clustering. The first aims at finding speaker change points in an audio stream. The second aims at grouping together speech segments on the basis of speaker characteristics. The speaker diarization engine 412 partitions audio data into segments and associates a speaker identity with each segment. For example, for an audio conversation with two speakers, the speaker diarization engine 412 can identify a speaker 1 (S1) and a speaker 2 (S2) and associate the partitioned segments with either S1 or S2 based on who is speaking at the time.

In one or more embodiments of the invention, once the audio data is segmented and the speakers identified by the speaker diarization engine 412, the STT engine 414 can translate the audio data into text. The STT engine 414 can include segmented sections of the audio and associated it with the speaker when translating to the text. For example, the text can be a set of segments including sentences, words, or phrases and the segments can be associated with a speaker next to the text for differentiation. The text of the audio data is first transcribed in the first language and then translated into one or more target languages. The number of target languages for translation is based on how many audio data translations are needed.

In one or more embodiments of the invention, the media engine 402 can utilize the translated text in the target language(s) and match the original speaker characteristics to the text to generate an output audio stream in the target language(s). The media engine 402 can analyze the audio in the media data input 404 to determine the time taken to pronounce certain words, phrases, or sentences (e.g., speech segments). After the audio is translated, the media engine 402 can match the time taken to pronounce, using the original speaker's voice, the translated or target language in the output audio. That is to the say, the translated audio is spoken in the original speaker's voice. In addition, the media engine 402 can utilize data expansion and compression techniques to match the speaker segments in the target language audio to the speaker segments in the audio in the original language. That is to say, the original speaker's audio timing in the original language matches with the original speaker's audio timing in the target language. In one or more embodiments of the invention, the media engine 402 can utilize expansion and compression techniques to also match the pitch of the audio to match the pitch and tone of the original speaker. In addition, the audio expansion and compression techniques can match the volume of the speaker's voice when speaking certain words in the translated media.

In one or more embodiments of the invention, the media engine 402 utilizes phonemes extracted from the original speaker in the media data input 404 to match to similar phonemes used in the pronunciation of the target language for the output media data 406. However, when there are no similar phonemes or there are missing phonemes for the original speaker, the media engine 402 can utilize phonemes from the generic speaker characteristics database 410 to fill in for the missing phonemes during the translation. The phonemes from the generic speaker characteristics database 410 can be utilized from various speakers that have similar speaker characteristics of the original speaker such as, for example, tone, cadence, accents, and the like. Similarly, audio compression and expansion techniques can be utilized on these phonemes to match the original speaker audio in the first language to the original speaker audio in the target language.

In one or more embodiments of the invention, the media engine 402 can utilize phonemes extracted from the original speaker in media data other than the media data input 404 and store in the original speaker characteristic database 408. For example, if an original speaker has appeared in several movies and/or has a number of speaking roles, the media engine 402 can analyze these movies and speaking roles to extract phonemes and other speaker characteristics to utilize for inclusion during the current translation and for any future translations. In some embodiments, the media engine 402 can generate one or more missing phonemes for a speaker. These missing phonemes can be mapped to certain words for the speaker to say in a recorded media in a certain language or in a number of languages, if the speaker is able to speak in more than one language. Based on the speaker uttering these certain words, the one or more missing phonemes can be extracted by the media engine 402 to store in the original speaker characteristic database 408 for use in the current translation or for any further translations.

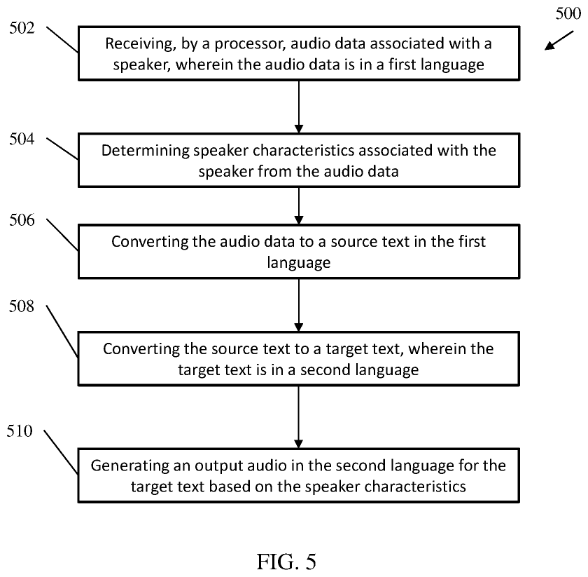

FIG. 5 depicts a flow diagram of a method for media language translation and synchronization according to one or more embodiments of the invention. The method 500 includes receiving, by a processor, audio data associated with a speaker, wherein the audio data is in a first language, as shown in block 502. The method 500, at block 504, includes determining speaker characteristics associated with the speaker from the audio data. The method 500 also includes converting the audio data to a source text in the first language, as shown at block 506. The method 500, at block 508, includes converting the source text to a target text, wherein the target text is in a second language. And at block 510, the method 500 includes generating an output audio in the second language for the target text based on the speaker characteristics.

Additional processes may also be included. It should be understood that the processes depicted in FIG. 5 represent illustrations, and that other processes may be added or existing processes may be removed, modified, or rearranged without departing from the scope and spirit of the present disclosure.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving, by a processor, audio data associated with a speaker, wherein the audio data is in a first language;
determining speaker characteristics associated with the speaker from the audio data;
converting the audio data to a source text in the first language;
converting the source text to a target text, wherein the target text is in a second language; and
generating an output audio in the second language for the target text based on the speaker characteristics.

2. The computer-implemented method of claim 1, wherein the determining the speaker characteristics associated with the speaker from the audio data comprises:
partitioning the audio data associated with the speaker into one or more segments; and
recording a length of time associated with each of the one or more segments;

3. The computer-implemented method of claim 2, wherein generating the output audio in the second language for the target text comprises:
generating first spoken audio for a first segment from the one or more segments, wherein the first spoken audio is in the second language.

4. The computer-implemented method of claim 3, wherein generating the first spoken audio for the first segment comprises:
performing an audio compression operation on the first spoken audio to match the speaker characteristics of the first segment in audio data and the length of time associated with the first segment.

5. The computer-implemented method of claim 3, wherein generating the first spoken audio for the first segment comprises:
performing an audio expansion operation on the first spoken audio to match the speaker characteristics of the first segment in audio data and the length of time associated with the first segment.

6. The computer-implemented method of claim 1, wherein the speaker characteristics associated with the speaker comprise phonemes of the speaker and tonal range.

7. The computer-implemented method of claim 2, wherein the one or more segments comprise at least one of a word, a phrase, and a sentence.

8. A system comprising:
a processor communicatively coupled to a memory, the processor configured to:
receive audio data associated with a speaker, wherein the audio data is in a first language;
determine speaker characteristics associated with the speaker from the audio data;
convert the audio data to a source text in the first language;
convert the source text to a target text, wherein the target text is in a second language; and
generate an output audio in the second language for the target text based on the speaker characteristics.

9. The system of claim 8, wherein the determining the speaker characteristics associated with the speaker from the audio data comprises:
partitioning the audio data associated with the speaker into one or more segments; and
recording a length of time associated with each of the one or more segments;

10. The system of claim 9, wherein generating the output audio in the second language for the target text comprises:
generating first spoken audio for a first segment from the one or more segments, wherein the first spoken audio is in the second language.

11. The system of claim 10, wherein generating the first spoken audio for the first segment comprises:
performing an audio compression operation on the first spoken audio to match the speaker characteristics of the first segment in audio data and the length of time associated with the first segment.

12. The system of claim 10, wherein generating the first spoken audio for the first segment comprises:
performing an audio expansion operation on the first spoken audio to match the speaker characteristics of the first segment in audio data and the length of time associated with the first segment.

13. The system of claim 8, wherein the speaker characteristics associated with the speaker comprise phonemes of the speaker and tonal range.

14. The system of claim 10, wherein the one or more segments comprise at least one of a word, a phrase, and a sentence.

15. A computer program product comprising a computer readable storage medium having program instructions embodied therewith, the program instructions executable by a processor to cause the processor to perform a method comprising:
receiving, by a processor, audio data associated with a speaker, wherein the audio data is in a first language;
determining speaker characteristics associated with the speaker from the audio data;
converting the audio data to a source text in the first language;
converting the source text to a target text, wherein the target text is in a second language; and
generating an output audio in the second language for the target text based on the speaker characteristics.

16. The computer program product of claim 15, wherein the determining the speaker characteristics associated with the speaker from the audio data comprises:
partitioning the audio data associated with the speaker into one or more segments; and
recording a length of time associated with each of the one or more segments.

17. The computer program product of claim 16, wherein generating the output audio in the second language for the target text comprises:
generating first spoken audio for a first segment from the one or more segments, wherein the first spoken audio is in the second language.

18. The computer program product of claim 17, wherein generating the first spoken audio for the first segment comprises:
performing an audio compression operation on the first spoken audio to match the speaker characteristics of the first segment in audio data and the length of time associated with the first segment.

19. The computer program product of claim 18, wherein generating the first spoken audio for the first segment comprises:
performing an audio expansion operation on the first spoken audio to match the speaker characteristics of the first segment in audio data and the length of time associated with the first segment.

20. The computer program product of claim 15, wherein the speaker characteristics associated with the speaker comprise phonemes of the speaker and tonal range.
